(19) United States
(12) Patent Application Publication
(10) Pub. No.: US 2018/0095608 A1
(43) Pub. Date: Apr. 5, 2018

(54) METHOD AND APPARATUS FOR CONTROLLING A VEHICLE

(71) Applicant: GM GLOBAL TECHNOLOGY OPERATIONS LLC, Detroit, MI (US)

(72) Inventor: Robert C. Jablonski, Rochester Hills, MI (US)

(21) Appl. No.: 15/285,741

(22) Filed: Oct. 5, 2016

(51) Int. Cl. G06F 3/0482; B60K 35/00; G06F 3/0481; G06F 3/0338; G06F 3/02; G06F 3/0484

(52) U.S. Cl. CPC G06F 3/0482; B60K 35/00; G06F 3/04847; G06F 3/0338; G06F 3/02; G06F 3/04817

(57) ABSTRACT

A method and apparatus for controlling speed are provided. The method includes: receiving a first input to display a cruise control menu on a display; in response to receiving the first input, displaying the cruise control menu including a plurality of cruise control submenu items comprising at least two from among a speed increase menu item, a speed decrease menu item, a speed set menu item, a cruise control pause menu item, and a cruise control cancel menu item; receiving a second input, from a unitary input, to initiate a function corresponding to one of the displayed plurality of cruise control submenu items; and in response to receiving the second input, performing the function corresponding to the one of the displayed plurality of cruise control submenu items. The method and apparatus may be used to set a speed of a vehicle by operating a unitary input.

### INTRODUCTION

Apparatuses and methods consistent with exemplary embodiments relate to controlling a vehicle. More particularly, apparatuses and methods consistent with exemplary embodiments relate to controlling the speed of a vehicle.

### SUMMARY

One or more exemplary embodiments provide a method and an apparatus that control the speed of a vehicle via a graphical user interface. More particularly, one or more exemplary embodiments provide a method and an apparatus that control the speed of a vehicle via a graphical user interface and a unitary input configured to control the graphical user interface.

According to an aspect of an exemplary embodiment, a method for controlling a speed of a vehicle is provided. The method includes: receiving a first input to display a cruise control menu on a display; in response to receiving the first input, displaying the cruise control menu including a plurality of cruise control submenu items comprising at least two from among a speed increase menu item, a speed decrease menu item, a speed set menu item, a cruise control pause menu item, and a cruise control cancel menu item; receiving, from a unitary input device, a second input to initiate a function corresponding to one of the displayed plurality of cruise control submenu items; and in response to receiving the second input, performing the function corresponding to the one of the displayed plurality of cruise control submenu items.

The receiving the first input may include at least one from among: depressing the unitary input device to select a cruise control icon displayed on the display to initiate a cruise control function and display the cruise control menu; and depressing a cruise control button to initiate the cruise control function and display the cruise control menu.

The second input may include at least one from among displacing the unitary input device in a horizontal direction and displacing the unitary input device in a vertical direction.

The second input comprises displacing and holding the unitary input in a displaced position for a predetermined threshold time, and in response to the second input, a plurality of selectable speed settings may be displayed on the display.

The displaying the plurality of cruise control submenu items may include displaying the plurality of cruise control submenu items on an instrument cluster.

The one of the displayed plurality of cruise control submenu items may include the speed set menu item, and the function may include fixing a speed of a vehicle to a speed measured by a speedometer of the vehicle.

The one of the displayed plurality of cruise control submenu items may include the cruise control cancel menu item, and the function may include unfixing the speed of the vehicle.

According to an aspect of an exemplary embodiment, an apparatus for controlling speed is provided. The apparatus include: a unitary input device comprising a depressible joystick; at least one memory comprising computer executable instructions; and at least one processor configured to read and execute the computer executable instructions. The computer executable instructions causing the at least one processor to: receive a first input to display a cruise control menu on a display; in response to receiving the first input, display the cruise control menu including a plurality of cruise control submenu items comprising at least two from among a speed increase menu item, a speed decrease menu item, a speed set menu item, a cruise control pause menu item, and a cruise control cancel menu item; receive, from a unitary input device, a second input to initiate a function corresponding to one of the displayed plurality of cruise control submenu items; and in response to receiving the second input, perform the function corresponding to the one of the displayed plurality of cruise control submenu items.

According to an aspect of another exemplary embodiment, a non-transitory computer readable medium comprising computer executable instructions executable by a processor to perform a method for controlling speed is provided. The method includes: receiving a first input to display a cruise control menu; in response to receiving the first input, displaying the cruise control menu including a plurality of cruise control submenu items comprising at least two from among a speed increase menu item, a speed decrease menu item, a speed set menu item, a cruise control pause menu item, and a cruise control cancel menu item; receiving, from a unitary input device, a second input to initiate a function corresponding to one of the displayed plurality of cruise control submenu items; and in response to receiving the second input, performing the function corresponding to the one of the displayed plurality of cruise control submenu items.

Other objects, advantages and novel features of the exemplary embodiments will become more apparent from the following detailed description of exemplary embodiments and the accompanying drawings.

### BRIEF DESCRIPTION OF THE DRAWINGS

FIG. 1 shows a block diagram of an apparatus that controls the speed of a vehicle via a graphical user interface, according to an exemplary embodiment;

FIG. 2 shows an illustration of a graphical user interface menu and input for controlling the speed of a vehicle, according to an aspect of an exemplary embodiment;

FIGS. 3A-3D shows an illustrations of a graphical user interface menu and input for controlling the speed of a vehicle, according to an aspect of an exemplary embodiment; and

FIG. 4 shows a flowchart for a method of controlling the speed of a vehicle, according to an aspect of an exemplary embodiment.

### DETAILED DESCRIPTION

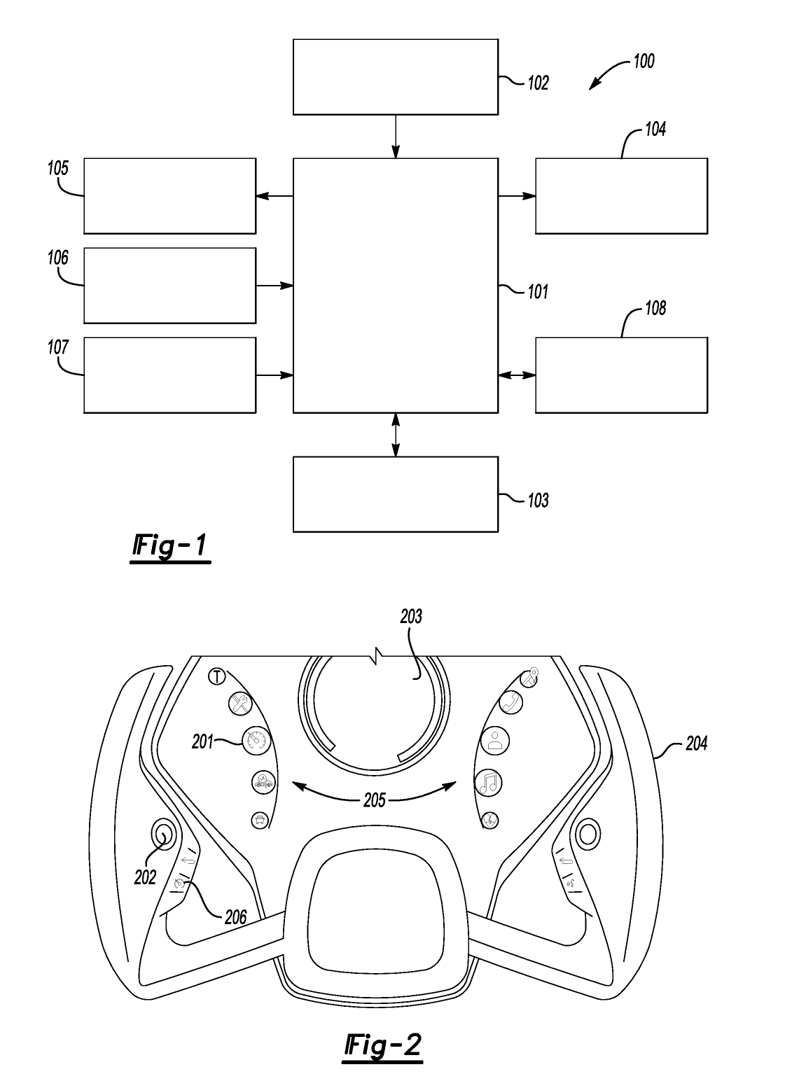

An apparatus and method for controlling the speed of a vehicle will now be described in detail with reference to FIGS. 1-4 of the accompanying drawings in which like reference numerals refer to like elements throughout.

The following disclosure will enable one skilled in the art to practice the inventive concept. However, the exemplary embodiments disclosed herein are merely exemplary and do not limit the inventive concept to exemplary embodiments described herein. Moreover, descriptions of features or aspects of each exemplary embodiment should typically be considered as available for aspects of other exemplary embodiments.

It is also understood that where it is stated herein that a first element is “connected to,” “formed on,” “attached to” or “disposed on” a second element, the first element may be connected directly to, formed directly on or disposed directly on the second element or there may be intervening elements between the first element and the second element, unless it is stated that a first element is “directly” connected to, formed on, attached to or disposed on the second element. In addition, if a first element is configured to “receive” or “send” information from or to a second element, the first element may receive or send the information directly from the second element, receive or send the information via a bus, receive or send the information via a network, or receive or send the information via intermediate elements, unless the first element is indicated to receive information “directly” from the second element or send information “directly” to the second element.

Throughout the disclosure, one or more of the elements disclosed may be combined into a single device or combined into one or more devices. In addition, individual elements may be provided on separate devices.

Controlling and/or fixing the speed of a vehicle via a cruise control system may be performed via one or more buttons positioned on the steering wheel. However, multiple buttons that are required to perform the functions of the cruise control system. Moreover, the multiple buttons occupy valuable space on the steering wheel. As automated control systems are incorporated into vehicles, user interfaces may be used to initiate, set, and modify settings for usually reserved for such controls.

FIG. 1 shows a block diagram of an apparatus for controlling the speed of a vehicle 100, according to an exemplary embodiment. As shown in FIG. 1, the apparatus for controlling the speed of a vehicle 100, according to an exemplary embodiment, includes a controller 101, a power supply 102, a storage 103, an output 104, a vehicle speed adjuster 105, a user input 106, a speed sensor 107, and a communication device 108. However, the apparatus for controlling the speed of a vehicle 100 is not limited to the aforementioned configuration and may be configured to include additional elements and/or omit one or more of the aforementioned elements.

The controller 101 controls the overall operation and function of the apparatus for controlling the speed of a vehicle 100. The controller 101 may control one or more of a storage 103, an output 104, a vehicle speed adjuster 105, a user input 106, a speed sensor 107, and a communication device 108 of the apparatus for controlling the speed of a vehicle 100. The controller 101 may include one or more from among a processor, a microprocessor, a central processing unit (CPU), a graphics processor, Application Specific Integrated Circuits (ASICs), Field-Programmable Gate Arrays (FPGAs), state machines, and a combination of hardware, software and firmware components.

The controller 101 is configured to send and/or receive information from one or more of the storage 103, the output 104, the vehicle speed adjuster 105, the user input 106, the speed sensor 107, and the communication device 108 of the apparatus for controlling the speed of a vehicle 100. The information may be sent and received via a bus or network, or may be directly read or written to/from one or more of the storage 103, the output 104, the vehicle speed adjuster 105, the user input 106, the speed sensor 107, and the communication device 108 of the apparatus for controlling the speed of a vehicle 100.

The power supply 102 provides power to one or more of the controller 101, the storage 103, the output 104, the vehicle speed adjuster 105, the user input 106, the speed sensor 107, and the communication device 108 of the apparatus for controlling the speed of a vehicle 100. The power supply 102 may include one or more from among a battery, an outlet, a capacitor, a solar energy cell, a generator, a wind energy device, an alternator, etc.

The storage 103 is configured for storing information and retrieving information used by the apparatus for controlling the speed of a vehicle 100. The storage 103 may be controlled by the controller 101 to store current speed information and speed setting information. The storage 103 may also include the computer instructions configured to be executed by a processor to perform the functions of the apparatus for controlling the speed of a vehicle 100.

The storage 103 may include one or more from among floppy diskettes, optical disks, CD-ROMs (Compact Disc-Read Only Memories), magneto-optical disks, ROMs (Read Only Memories), RAMs (Random Access Memories), EPROMs (Erasable Programmable Read Only Memories), EEPROMs (Electrically Erasable Programmable Read Only Memories), magnetic or optical cards, flash memory, cache memory, and other type of media/machine-readable medium suitable for storing machine-executable instructions.

The output 104 outputs information in one or more forms including: visual, audible and/or haptic form. The output 104 may be controlled by the controller 101 to provide outputs to the user of the apparatus for controlling the speed of a vehicle 100. The output 104 may include one or more from among a speaker, a centrally-located a display, an instrument panel display, a head up display, a windshield display, a haptic feedback device, a vibration device, a tactile feedback device, a tap-feedback device, a holographic display, an instrument light, an instrument panel display, an indicator light, etc.

The output 104 may output notifications including one or more from among an audible notification, a light notification, and a display notification. The output 104 may also display graphical icons and/or text as part of a menu including menu items or as part of submenu including submenu items. The output 104 may also output an audible notification if a menu item or a submenu item is selected. Moreover, the output 104 may display a highlight on a menu item or a submenu item when either is selected. A highlight may include one or more from among enlarging the menu or submenu item, increasing the brightness of the menu or submenu item, adding a selection graphic to the menu or submenu item, etc.

In one example, the output 104 may display a cruise control icon as part of a menu including a plurality of icons on an instrument cluster display. In another example, the output 104 may display a plurality of a plurality of cruise control submenu items including one or more from among a speed increase menu item, a speed decrease menu item, a speed set menu item, and a cruise control cancel menu item as part of another menu on an instrument cluster display. In yet another example, the output 104 may indicate a selected icon or selected submenu item by highlighting the selected icon or submenu item. The cruise control icon and submenu items may include one or more from among text indicating a function of the icon or submenu item and a graphic illustrating a function of the icon or submenu item.

The vehicle speed adjuster 105 is configured to adjust a speed of the vehicle. The vehicle speed adjuster 105 may include one or more from among a throttle adjuster, a variable resistor, a current controller, a voltage controller, a brake actuator, etc. The vehicle speed adjuster 105 may adjust a speed of a vehicle based on a gap setting that sets a gap between the vehicle and another vehicle traveling in front of or behind the vehicle. In one example, vehicle speed adjuster 105 may adjust a speed based on fore and aft gap settings to maintain distances between a vehicle and vehicles traveling in front of or behind the vehicle

The user input 106 is configured to provide information and commands to the apparatus for controlling the speed of a vehicle 100. The user input 106 may be used to provide user inputs, etc. to the controller 101. The user input 106 may include one or more from among a touchscreen, a keyboard, a soft keypad, a button, a motion detector, a voice input detector, a microphone, a camera, a trackpad, a mouse, a depressible joystick, a depressible two axis control, a touchpad, a unitary input, a unitary input device, etc. The user input 106 may be configured to receive a user input to acknowledge or dismiss the notification output by the output 104. The user input 106 may also be configured to receive a user input to cycle through notifications or different screens of a notification.

The speed sensor 107 is configured to detect a speed of the vehicle. The speed sensor 107 may include one or more from among a speedometer, a global positioning system (GPS) receiver, a radar, a laser detector, etc. The speed sensor 107 is configured to detect a speed of the vehicle and provide information on the speed of the vehicle to the controller 101.

The communication device 108 may be used by apparatus for controlling the speed of a vehicle 100 to communicate with various types of external apparatuses according to various communication methods. The communication device 108 may be used to send or receive speed information such as the speed of the vehicle and speed control information used to control the speed adjuster 105.

The communication device 108 may include various communication modules such as one or more from among a broadcast receiving module, a near field communication (NFC) module, a GPS receiver, a wired communication module, or a wireless communication module. The broadcast receiving module may include a terrestrial broadcast receiving module including an antenna to receive a terrestrial broadcast signal, a demodulator, and an equalizer, etc. The NFC module is a module that communicates with an external apparatus located at a nearby distance according to an NFC method. The GPS receiver is a module that receives a GPS signal from a GPS satellite and detects a current location. The wired communication module may be a module that receives information over a wired network such as a local area network, a controller area network (CAN), or an external network. The wireless communication module is a module that is connected to an external network by using a wireless communication protocol such as Wi-Fi or IEEE communication protocol and communicates with the external network. The wireless communication module may further include a mobile communication module that accesses a mobile communication network and performs communication according to various mobile communication standards such as 3^{rd} generation (3G), 3rd generation partnership project (3GPP), long term evolution (LTE), Bluetooth, or ZigBee.

According to an exemplary embodiment, the controller 101 of the apparatus for controlling the speed of a vehicle 100 is configured to receive a first input to display a cruise control menu on a display, in response to receiving the first input, display the cruise control menu including a plurality of cruise control submenu items comprising at least two from among a speed increase menu item, a speed decrease menu item, a speed set menu item, a cruise control pause menu item, and a cruise control cancel menu item, receive, from a unitary input device, a second input to initiate a function corresponding to one of the displayed plurality of cruise control submenu items, and in response to receiving the second input, perform the function corresponding to the one of the displayed plurality of cruise control submenu items.

The unitary input device may be a joystick that is present on the steering wheel. The first input may include depressing the unitary input device to select a cruise control icon displayed on the display to initiate a cruise control function and display the cruise control menu; and depressing a cruise control button to initiate the cruise control function and display the cruise control menu. The second input may include displacing the unitary input device in a horizontal direction or displacing the unitary input device in a vertical direction.

The second input may include displacing and holding the unitary input in a displaced position for a predetermined threshold time, and the controller 101 may be configured to display a plurality of selectable speed settings on the display in response to the second input. The selectable speed settings may be scrolled by using the unitary input to select the desired speed setting. According to an example, the cruise control button may include a toggle button configured to toggle the cruise control function on and off when the toggle button is depressed.

According to an example, the function controlled by the speed set menu item may include fixing a speed of a vehicle to a speed measured by a speedometer of the vehicle. According to another example, the function controlled by the cruise control cancel menu item may include unfixing the speed of the vehicle.

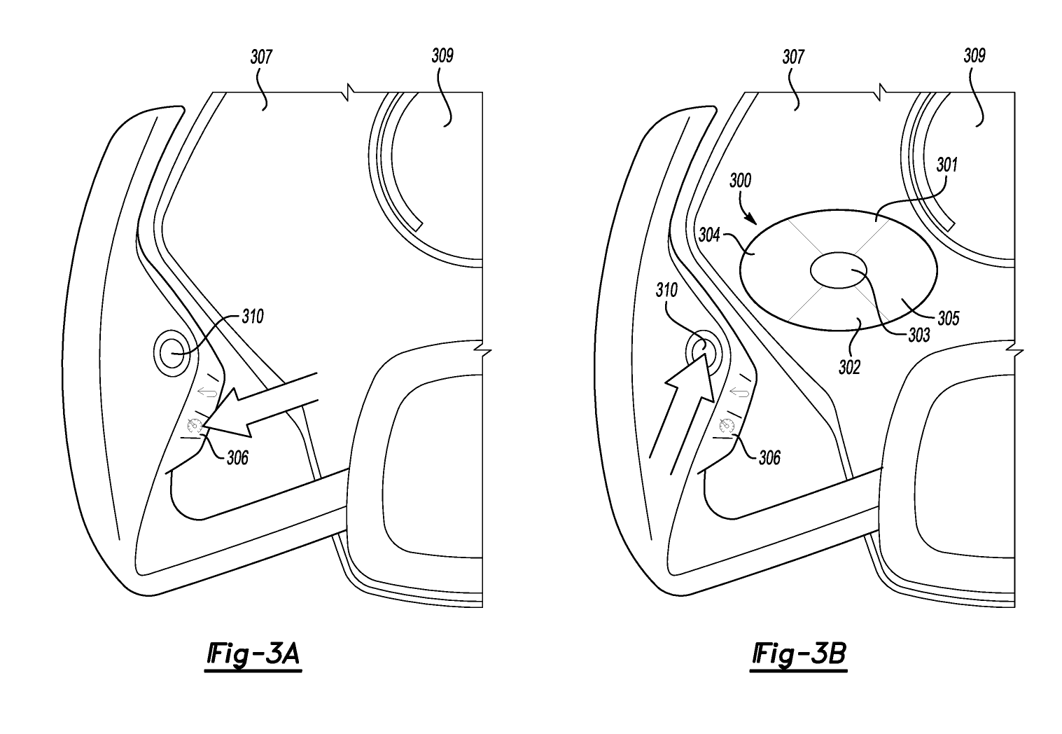

FIG. 2 shows an illustration of an apparatus for controlling the speed according to an aspect of an exemplary embodiment. In particular, FIG. 2 shows an illustration of a graphical user interface menu and unitary input for operating the user interface menu to control the speed of a vehicle

Referring to FIG. 2, a plurality of menu items 205 may be displayed in an instrument cluster 203. The plurality of menu items 205 may be presented in the form of one or more from among graphics, icons, images, text, etc. A cruise control menu item 201 may be selected by operation of a unitary input device 202 located on steering wheel 204. The unitary input device 202 may be a depressible joystick control. The unitary input device 202 may also be positioned in another location accessible to a vehicle operator such as on a dashboard, a center console, a human machine interface (HMI) stack, etc. The selection of the cruise control menu item 201 may bring up a plurality of submenu items including one or more from among a speed increase menu item, a speed decrease menu item, a speed set menu item, a cruise control pause menu item, a cruise control resume menu item and a cruise control cancel menu item.

In addition, a cruise control toggle button 206 may be used to toggle a cruise control function on and off. The cruise control on function initiates a cruise control menu to bring up a plurality of submenu items including one or more from among a speed increase menu item, a speed decrease menu item, a speed set menu item, a cruise control pause menu item, and a cruise control cancel menu item. The cruise control toggle button 206 may include a “cruise control on” graphical indicator that is displayed when the cruise control is off and this may change to a “cruise control off” graphical indicator that is displayed when the cruise control is on.

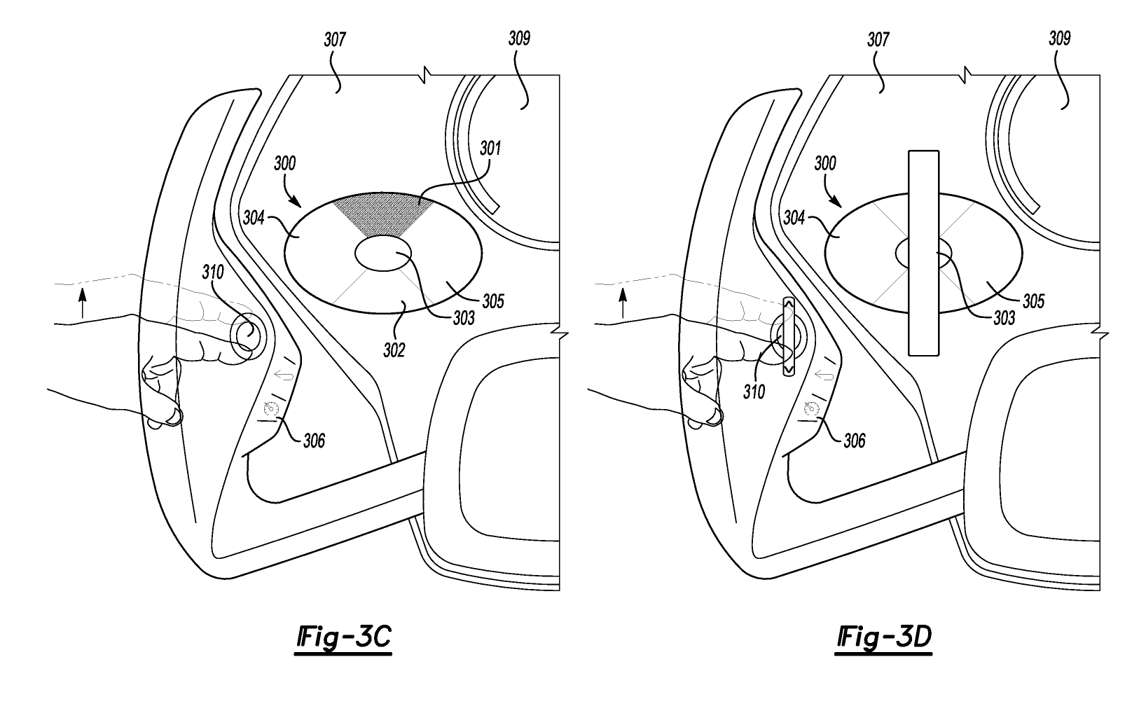

FIGS. 3A-3D show an illustrations of an apparatus for controlling the speed according to an aspect of an exemplary embodiment. In particular, FIGS. 3A-3D show illustrations of a graphical user interface menus for controlling a cruise control function of a vehicle and a unitary input device for operating the user interface menu to control the speed of the vehicle.

Referring to FIG. 3A, the selection of the cruise control menu item 201 or cruise control toggle button 306, initiates a cruise control function and the display of a cruise control menu 300 including a plurality of cruise control submenu items.

Referring to FIG. 3B, the cruise control menu 300 including a plurality of cruise control submenu items may include one or more from among a speed increase menu item 301, a speed decrease menu item 302, a speed set menu item 303, a cruise control pause menu item 304, and a cruise control resume menu item 305 may be displayed on instrument cluster 307. The cruise control menu 300 may be displayed to one side of an instrument panel display cluster 307 or one side of the speedometer display 309. However, the cruise control menu 300 may be displayed in other places including a heads up display, a center stack display, and one other devices of the output 104. In addition, a super cruise menu item may be displayed as part of the cruise control menu 300. The super cruise menu item may be selected to initiate one or more automated driving functions including lane assist, controlling the distance between a vehicle and other vehicles on the road, and fully automated driving.

Referring to FIGS. 3B and 3C, the unitary input device 310 may be used to select one from among a speed increase menu item 301, a speed decrease menu item 302, a cruise control pause menu item 304, and a cruise control resume menu item 305 that may be displayed on instrument panel display cluster 307 by tilting, sliding or displacing the unitary input device 310 along a horizontal, diagonal or vertical axis. For example, the unitary input device 310 may be displaced up to select a speed increase menu item 301 as shown in FIG. 3C, may be displaced down to select a speed decrease menu item 302, may be displaced to the left to select a cruise control pause menu item 304, and may be displaced to the right to select a cruise control resume menu item 305. The unitary input device 310 may be depressed to initiate a function of the speed set menu item 303.

The speed increase menu item 301 may be initiated to increase a speed of a vehicle by predetermined interval or step. The speed decrease menu item 302 may be initiated to decrease a speed of a vehicle by predetermined interval or step. The speed set menu item 303 may be initiated to set the speed of a vehicle to a speed corresponding to a current traveling speed of the vehicle or to the speed shown on the speedometer display 309. The cruise control pause menu item 304 may be initiated to temporarily deactivate the speed control of a vehicle. This vehicle may then resume speed control at a previously set speed by selecting a cruise control resume menu item (not shown), which may be displayed in place of the cruise control pause menu item 304 after cruise control is paused or which may be displayed in another position in the cruise control menu 300. The cruise control resume menu item 305 may be initiated to resume cruise control at a previously set speed after pausing the cruise control function with the cruise control pause menu item 304. Alternatively, the cruise control resume menu item 305 may be replaced with a cruise control cancel menu item that may be initiated to cancel or deactivate the speed control of a vehicle or a super cruise control or autonomous control menu item that may be initiated to activate automated driving features.

Referring to FIG. 3D, the unitary input device 310 may be displaced and held in the displaced position for a predetermined threshold time. For example, the unitary input device 310 may be tilted and held, slid and held, etc. After the unitary input device 310 is held in the displaced position for a predetermined period of time, a speed setting menu 308 including a plurality of selectable speed settings may be displayed in a vertical strip on the display. The plurality of selectable speed settings may be scrolled as long as the unitary input device 310 is displaced and the speed setting located in a center position 303 may be set as the cruising speed after the unitary input device 310 is released from being held.

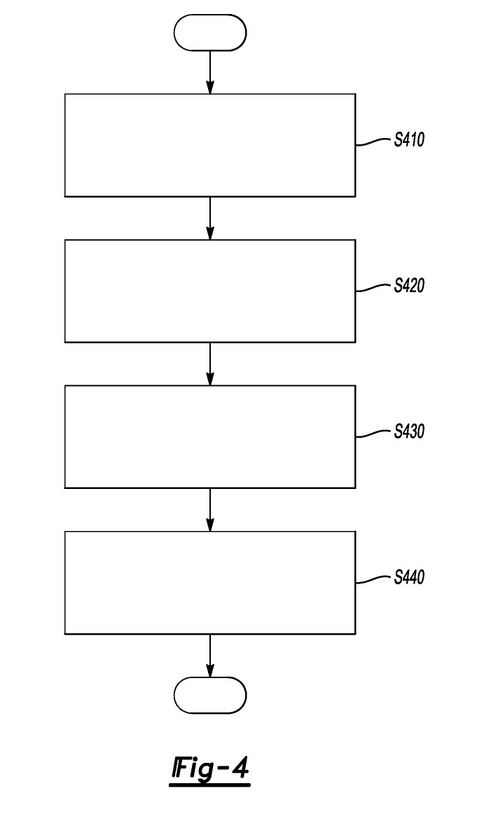

FIG. 4 shows a flowchart for flowchart for a method of controlling the speed of a vehicle, according to an aspect of an exemplary embodiment. The method of FIG. 4 may be performed by the apparatus for controlling the speed of a vehicle 100 or may be encoded into a computer readable medium as instructions that are executable by a computer to perform the method.

Referring to FIG. 4, a first input to display a cruise control menu is received from the unitary input device in operation S410. In response to receiving the first input, a plurality of cruise control submenu items are displayed in operation S420. Then, a second input to initiate function corresponding to one of displayed plurality of cruise control submenu items is received from the unitary input device in operation S430. In response to receiving the second input, a function corresponding to one of the displayed plurality of cruise control submenu items is performed in operation S440.

The method of FIG. 4 may be performed by omitting one or more operations. Moreover, the operations shown may be performed out of order.

The processes, methods, or algorithms disclosed herein can be deliverable to/implemented by a processing device, controller, or computer, which can include any existing programmable electronic control device or dedicated electronic control device. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

One or more exemplary embodiments have been described above with reference to the drawings. The exemplary embodiments described above should be considered in a descriptive sense only and not for purposes of limitation. Moreover, the exemplary embodiments may be modified without departing from the spirit and scope of the inventive concept, which is defined by the following claims.

What is claimed is:

1. A method for controlling a speed of a vehicle, the method comprising:
receiving a first input to display a cruise control menu on a display;
in response to receiving the first input, displaying the cruise control menu including a plurality of cruise control submenu items comprising at least two from among a speed increase menu item, a speed decrease menu item, a speed set menu item, a cruise control pause menu item, and a cruise control cancel menu item;
receiving, from a unitary input device, a second input to initiate a function corresponding to one of the displayed plurality of cruise control submenu items; and
in response to receiving the second input, performing the function corresponding to the one of the displayed plurality of cruise control submenu items.

2. The method of claim 1, wherein the receiving the first input comprises at least one from among: depressing the unitary input device to select a cruise control icon displayed on the display to initiate a cruise control function and display the cruise control menu; and
depressing a cruise control button to initiate the cruise control function and display the cruise control menu.

3. The method of claim 2, wherein the second input comprises at least one from among displacing the unitary input device in a horizontal direction and displacing the unitary input device in a vertical direction.

4. The method of claim 2, wherein the cruise control button comprises a toggle button configured to toggle the cruise control function on and off.

5. The method of claim 2, wherein the second input comprises displacing and holding the unitary input in a displaced position for a predetermined threshold time, and
wherein, in response to the second input, a plurality of selectable speed settings are displayed on the display.

6. The method of claim 1, wherein the displaying the plurality of cruise control submenu items comprises displaying the plurality of cruise control submenu items on an instrument cluster.

7. The method of claim 1, wherein the unitary input device is located on a steering wheel.

8. The method of claim 1, wherein the one of the displayed plurality of cruise control submenu items comprises the speed set menu item, and
wherein the function comprises fixing a speed of a vehicle to a speed measured by a speedometer of the vehicle.

9. The method of claim 8, wherein the one of the displayed plurality of cruise control submenu items comprises the cruise control cancel menu item, and
wherein the function comprises unfixing the speed of the vehicle.

10. A non-transitory computer readable medium comprising computer executable instructions executable by a processor to perform the method of claim 1.

11. An apparatus for controlling speed, the apparatus comprising:
a unitary input device comprising a depressible joystick;
at least one memory comprising computer executable instructions; and
at least one processor configured to read and execute the computer executable instructions, the computer executable instructions causing the at least one processor to:
receive a first input to display a cruise control menu on a display;
in response to receiving the first input, display the cruise control menu including a plurality of cruise control submenu items comprising at least two from among a speed increase menu item, a speed decrease menu item, a speed set menu item, a cruise control pause menu item, and a cruise control cancel menu item;
receive, from a unitary input device, a second input to initiate a function corresponding to one of the displayed plurality of cruise control submenu items; and
in response to receiving the second input, perform the function corresponding to the one of the displayed plurality of cruise control submenu items.

12. The apparatus of claim 11, wherein the first input comprises
depressing the unitary input device to select a cruise control icon displayed on the display to initiate a cruise control function and display the cruise control menu; and
depressing a cruise control button to initiate the cruise control function and display the cruise control menu.

13. The apparatus of claim 12, wherein the second input comprises at least one from among displacing the unitary input device in a horizontal direction and displacing the unitary input device in a vertical direction.

14. The apparatus of claim 12, wherein the cruise control button comprises a toggle button configured to toggle the cruise control function on and off.

15. The apparatus of claim 12, wherein the second input comprises displacing and holding the unitary input in a displaced position for a predetermined threshold time, and
wherein the computer executable instructions cause the at least one processor to display a plurality of selectable speed settings on the display in response to the second input.

16. The apparatus of claim 11, further comprising an instrument cluster comprising the display.

17. The apparatus of claim 11, further comprising a steering wheel comprising the unitary input device.

18. The apparatus of claim 11, wherein the one of the displayed plurality of cruise control submenu items comprises the speed set menu item, and
wherein the function comprises fixing a speed of a vehicle to a speed measured by a speedometer of the vehicle.

19. The apparatus of claim 18, wherein the one of the displayed plurality of cruise control submenu items comprises the cruise control cancel menu item, and
wherein the function comprises unfixing the speed of the vehicle.

20. A non-transitory computer readable medium comprising computer executable instructions executable by a processor to perform a method for controlling speed, the method comprising:
receiving a first input to display a cruise control menu;
in response to receiving the first input, displaying the cruise control menu including a plurality of cruise control submenu items comprising at least two from among a speed increase menu item, a speed decrease menu item, a speed set menu item, a cruise control pause menu item, and a cruise control cancel menu item;
receiving, from a unitary input device, a second input to initiate a function corresponding to one of the displayed plurality of cruise control submenu items; and
in response to receiving the second input, performing the function corresponding to the one of the displayed plurality of cruise control submenu items.
